(19) United States
(12) Patent Application Publication
(10) Pub. No.: US 2011/0055358 A1
(43) Pub. Date: Mar. 3, 2011

(54) DOWNLOADING METHOD FOR TERMINAL AND METHOD FOR CONTROLLING DOWNLOAD

(75) Inventors: Jongkuk LEE, Daejeon (KR); Ki Dong Nam, Daejeon (KR); Dae Young Kim, Daejeon (KR)

(73) Assignee: ELECTRONICS AND TELECOMMUNICATIONS RESEARCH INSTITUTE, Daejeon (KR)

(21) Appl. No.: 12/872,798

(22) Filed: Aug. 31, 2010

(30) Foreign Application Priority Data
Sep. 1, 2009 (KR) 10-2009-0082088
Jun. 1, 2010 (KR) 10-2010-0051832

(51) Int. Cl. G06F 15/16

(52) U.S. Cl. 709/219; 709/229

(57) ABSTRACT

A terminal receives information of files required for a service and address information of a file agent storing the files from a server connected via a network, and downloads the files from the file agent corresponding to the address information received from the server.

### CROSS-REFERENCE TO RELATED APPLICATION

This application claims priority to and the benefit of Korean Patent Application Nos. 10-2009-0082088 and 10-2010-0051832 filed in the Korean Intellectual Property Office on Sep. 1, 2009 and Jun. 1, 2010, the entire contents of which are incorporated herein by reference.

### BACKGROUND OF THE INVENTION

(a) Field of the Invention

The present invention relates to a downloading method for a terminal and method for controlling download.

(b) Description of the Related Art

A system operates in the order of hardware, a bootloader, an operating system (OS) kernel, an OS, and applications.

The bootloader functions to enable the system to be booted to the OS installed in the system. To this end, the bootloader finds the OS and application files in a given auxiliary storage device and loads them to a main storage device, or finds the OS and application files at a given address via a network and loads them to the main storage device. In order to find the OS and application files in the auxiliary storage device and load them, all files have to be stored in advance in the auxiliary storage device, and in order to load a file via the network, it is necessary for a user to know information such as a file name, the address of the server providing the file, etc.

However, in this method, one terminal alone cannot cover all services from various service providers.

For example, there are a large number of service providers of VoIP phones or IPTV set top boxes. Moreover, the service providers of VoIP phones or IPTV set top boxes do not establish conventional standards and have been developing a variety of different services to be distinguished from their competitors, and each service provider has their developed services embedded in each individual terminal. Therefore, if the application file of a certain service is not present in the terminal, the user has to purchase a terminal having the application file of the service embedded therein. Further, each time they change their service providers, the user will suffer the inconvenience of having to install the OS and applications of the terminal in order to get the services provided by the service provider.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a downloading method for a terminal that allows for easy downloading of operating system files and application files.

One exemplary embodiment of the present invention provides a downloading method for a terminal. The downloading method includes: selecting a desired service; receiving information of a file required for the service and address information of a file agent storing the file from the server; and downloading the file from the file agent corresponding to the address information.

Another exemplary embodiment of the present invention provides a downloading method for a terminal. The downloading method includes: selecting a desired service; receiving information of a file required for the service and location information of the file from the server; and downloading the file based on the location information.

Yet another embodiment of the present invention provides a method of controlling download of a terminal from a server. The method comprises receiving service that a terminal selects from the terminal, and transmitting to the terminal information of a file required for the service and address information for locating the file.

### BRIEF DESCRIPTION OF THE DRAWINGS

FIG. 1 is a view showing a network system to which the present invention is applied.

FIG. 2 is a view showing a downloading method for a terminal according to an exemplary embodiment of the present invention.

FIG. 3 is a view showing an update method for a terminal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise” and variations such as “comprises” or “comprising” will be understood to imply the inclusion of stated elements but not the exclusion of any other elements.

Now, a downloading method for a terminal and method for controlling download according to an exemplary embodiment of the present invention will be described in detail with reference to the accompanying drawings.

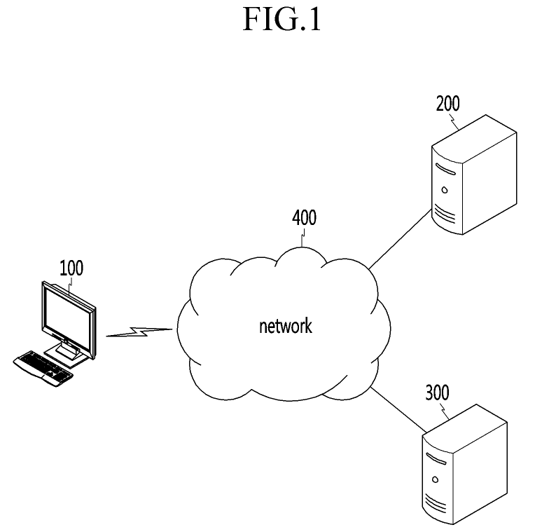

FIG. 1 is a view showing a network system to which the present invention is applied.

Referring to FIG. 1, the network system includes a terminal 100, a server 200, and a file agent 300.

The terminal 100 is connected to the server 200 and the file agent 300 via a network 400. The terminal 100 receives location information of OS and application files required for a desired service from the server 200, and downloads and updates the OS and application files corresponding to the location information of the OS and application files, from the file agent 300. The location information of the OS and application files may be the address of the file agent 300 having the OS and application files.

The server 200 stores a service list of available services and address information of the file agent 300 having the OS and application files required for each service. Therefore, when the terminal 100 selects a desired service, the server 200 transmits name information of the OS and application files required for the selected service and the address information of the file agent having the OS and application files to the terminal 100. At this point, the server 200 may encrypt the name information of the OS and application files and the address information of the file agent having the OS and application files and transmit them to the terminal 100.

Moreover, upon receipt of an update registration request from the file agent 300, the server 200 notifies the terminal 100 that has downloaded the corresponding OS and application files of update information.

The file agent 300 stores different OS and application files therein. These OS and application files may include source files and update files.

Further, when update files for the OS and application files are created, the file agent 300 sends an update registration request to the server 200 to download the update files from the terminal 100.

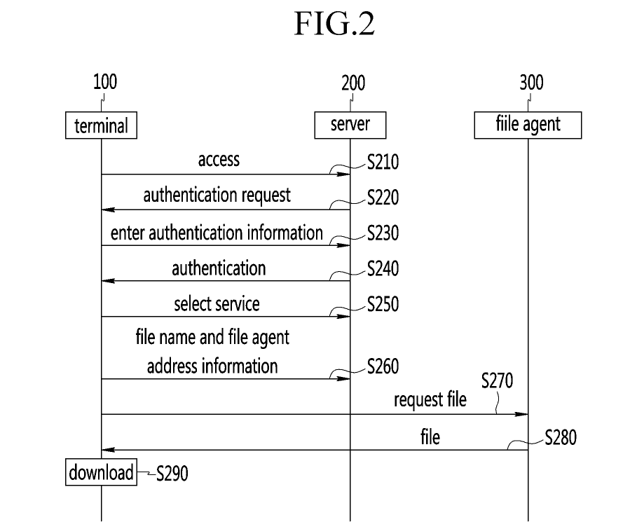

FIG. 2 is a view showing a downloading method for a terminal according to an exemplary embodiment of the present invention.

Referring to FIG. 2, when the terminal 100 accesses the server 200 (S210), the server 100 makes an authentication request to the terminal 100 while transmitting a service list and basic information about the network to the terminal 100 (S220). At this time, the terminal 100 is able to use the network using the basic information about the network.

The terminal 100 enters authentication information to make an authentication request (S230), and the server 200 authenticates the terminal 100 (S240).

When the authentication is successfully made, the terminal 100 selects a desired service from the service list and transmits it to the server (S250).

The server 200 transmits information such as the names of the OS and application files required for the service requested by the terminal and location information of these files, i.e., address information of the file agent storing these files (S260), to the terminal 100. At this point, the server 200 is able to encrypt the information such as the names of the OS and application files and the address of the file agent storing these files and transmit it to the terminal 100.

Upon receipt of the names of the OS and application files and the address information of the file agent from the server 200, the terminal 100 sends a request for the OS and application files to the corresponding file agent 300 (S270).

Having received the request for the OS and application files from the terminal 100, the file agent 300 transfers the OS and application files to the terminal 100 (S280).

The terminal 100 downloads the OS and application files transferred from the file agent 300 (S290).

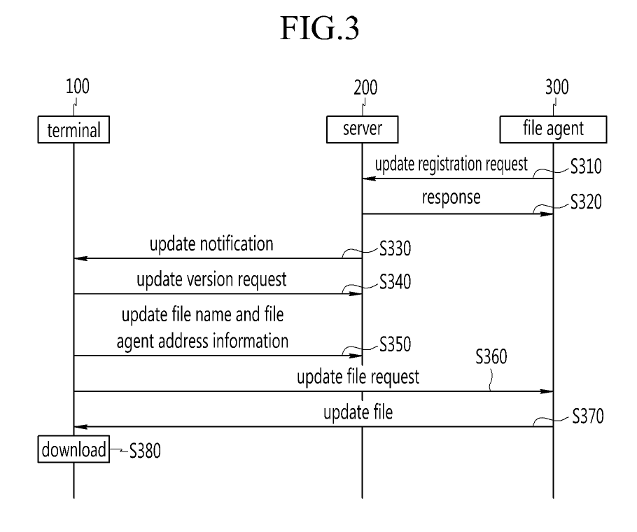

FIG. 3 is a view showing an update method for a terminal according to an exemplary embodiment of the present invention.

Referring to FIG. 3, when an update versions of the OS and application files are created, the file agent 300 sends an update registration request to the server 200 (S310).

The server 200 sends a response to the update registration request to the file agent 300 (S320), and transmits update information to the terminal 100 to notify the terminal 100 that there are update versions (S330).

The terminal 100 sends a request for the update versions of the OS and application files to the server 200 (S340), and the server 200 transmits information such as the names of the update versions and the address information of the file agent 300 storing the update versions to the terminal 100 (S350).

Upon receipt of the names of the update versions and the address information of the file agent 300 from the server 200, the terminal 100 makes an update file request to the file agent 300 corresponding to the address information while transmitting the name information of the update versions to the file agent (S360).

Having received the update file request from the terminal 100, the file agent 300 transfers the update files (S370), and the terminal 100 downloads the update files (S380).

If one device provides the functions of the server 200 and the file agent 300, the load applied to the corresponding device becomes greater when there are a large number of terminals. Moreover, each small network to which various types of terminals are attached has to be equipped with the corresponding device, thus incurring high installation costs. However, in the exemplary embodiment of the present invention, the server 200 provides the information about the OS and application files and the file agent 300 provides the OS and application files, whereby the load applied to one device can be distributed to the server 200 and the file agent 300, respectively. Moreover, since the file agent 300 that is expensive and the server 200 that is inexpensive are separated, the server 200 can be installed for each network and the file agent 300 can be installed for a set of integrated networks, so the installation costs can also be reduced.

According to the exemplary embodiments of the present invention, since the operating system and application files are downloaded and updated via a network, there is no need to newly install the operating system and application files of a terminal when changing service providers, and the services provided by various service providers can be provided without replacing a terminal.

The above-described exemplary embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A downloading method for a terminal, comprising:
selecting a desired service;
receiving information of a file required for the service and address information of a file agent storing the file from the server; and
downloading the file from the file agent corresponding to the address information.

2. The method of claim 1, further comprising:
receiving update information of the file from the server;
receiving a name of an update version of the file and address information of the file agent storing the update version from the server; and
downloading the update version from the file agent corresponding to the address information.

3. The method of claim 1, further comprising obtaining authentication from the server before the selection.

4. The method of claim 1, further comprising:
accessing the server; and
receiving a service list from the server.

5. The method of claim 1, wherein the terminal is connected to the server and the file agent via a network.

6. The method of claim 1, wherein the file includes an operating system and application files required for booting.

7. A downloading method for a terminal, comprising:
selecting a desired service;
receiving information of a file required for the service and location information of the file from the server; and
downloading the file based on the location information.

8. The method of claim 7, further comprising:
receiving update information of the file from the server;
receiving a name of an update version of the file and location information of the update version from the server; and
downloading the update version based on the location information.

9. The method of claim 7, wherein the location information includes address information of a file agent that is connected to the terminal and the server via a network.

10. The method of claim 7, wherein the file includes an operating system and application files required for booting.

11. The method of claim 7, wherein the information of the file and the location information are encrypted and transmitted by the server.

12. A method of controlling download of a terminal from a server, the method comprising:
receiving service that a terminal selects from the terminal; and
transmitting to the terminal information of a file required for the service and address information for locating the file.

13. The method of claim 12, further comprising:
receiving an update registration request of the file from a file agent corresponding to the address information;
notifying the terminal that there are updated versions of the file;
receiving a request to update the file from the terminal; and
transmitting a name of the updated file and address information storing the updated file to the terminal by replying to the request.

14. The method of claim 12, wherein the file comprises an operating system and application files required for booting.

15. The method of claim 12, wherein the transmitting includes encrypting the information of the file and the address information.
